(19) United States
(12) Patent Application Publication
(10) Pub. No.: US 2025/0002347 A1
(43) Pub. Date: Jan. 2, 2025

(54) COMPOSITE MATERIALS WITH TUNABLE POROSITY AND THE PREPARATION AND USES THEREOF

(71) Applicant: Aspen Aerogels, Inc., Northborough, MA (US)

(72) Inventors: Zhifei Li, Marlborough, MA (US); Wei Xie, Everett, MA (US)

(73) Assignee: Aspen Aerogels, Inc., Northborough, MA (US)

(21) Appl. No.: 18/882,347

(22) Filed: Sep. 11, 2024

Related U.S. Application Data
(63) Continuation of application No. PCT/US2023/070426, filed on Jul. 18, 2023.
(60) Provisional application No. 63/390,845, filed on Jul. 20, 2022.

(51) Int. Cl. C01B 32/05

(52) U.S. Cl. CPC C01B 32/05; C01P 2002/08; C01P 2006/14; C01P 2006/16; C01P 2006/40

(57) ABSTRACT

Provided herein are composite materials for use in an electrical energy storage system (e.g., a high-capacity battery) and methods for preparing the same. The composite materials provided herein are also useful as substrates for chemical vapor deposition of silicon. The composite materials of the present disclosure include a three-dimensional carbon network and optional silicon particles. The composite materials further include mega pores, at least some of which are formed by carbonizing sacrificial particles dispersed throughout a three-dimensional network. The mega pores advantageously provide a space to accommodate the strain and stress in the electrode structure due to volume changes of silicon (particles) during charge and discharge of the electrical energy storage system.

### CROSS REFERENCES TO RELATED APPLICATIONS

This application is a continuation of International PCT Application No. PCT/US2023/070426, filed Jul. 18, 2023 which claims priority to and the benefit of U.S. Provisional Patent Application No. 63/390,845, filed Jul. 20, 2022, which is herein incorporated by reference in its entirety.

### FIELD OF THE TECHNOLOGY

The present disclosure relates generally to composite materials comprising void space (e.g., mega pores) for use in an electrical energy storage system (e.g., a high-capacity battery) and methods for preparing the same. More specifically, it relates to materials and methods for producing composite materials including a three-dimensional carbon network, optional silicon particles and mega pores, at least some of which are formed by carbonizing a plurality of sacrificial particles dispersed throughout a three-dimensional network.

### BACKGROUND

High-capacity battery materials e.g., lithium-ion batteries (LIBs) have been recognized as the most promising energy storage technology for a wide range of applications, from consumer electronics, electric vehicles to renewable energy storage. Despite varying requirements of diverse applications, Li-ion batteries with high capacities and long cycling lives are generally essential.

Silicon is one of the most promising anode materials for lithium-ion batteries because of the highest known theoretical capacity and abundance in the earth's crust. Silicon has been shown to have a high theoretical gravimetric capacity, approximately 4200 mAh/g, compared to only 372 mAh/g for graphite. Therefore, silicon (Si) active material has been considered as promising candidate for next-generation anodes in lithium-ion batteries.

However, silicon is known to experience a significant “breathing effect” during insertion/de-insertion of lithium in the continuous charge-discharge processes, which undermines the advantage of silicon's high capacity. This “breathing effect” causes serious structural degradation and results in losing specific capacity and increasing battery impedance. That is, the volume of Si can expand approximately 400% of its original size during lithiation (the insertion of lithium-ions into silicon), then reducing to a varying size during de-lithiation (the extraction of lithium-ions from silicon). The significant volume change poses a real challenge for Si electrodes to retain its morphology over cycling.

With each cycle, the expansion produces stress and strain on the silicon, causing cracks and breakage. The process of the silicon breaking down is known as pulverization. Due to this pulverization, electrical isolation of silicon fragments causes a loss in contact with neighboring fragments. In addition, the space created from the expansion pushing surrounding conducting material away from the active material also causes a loss of contact, resulting in low electrical conductivity. Without strong electrical contact with the current collector, the silicon fragments are not lithiated or able to contribute to the battery's capacity. This behavior yields low-capacity stability and rapid capacity degradation over a number of cycles. The decrease in capacity during charging and discharging cycles is referred to as fading or continuous capacity decrease and is generally irreversible.

The particle size of the silicon particles can play a role in how quickly the battery performance declines. Without being bound by theory, nanometer-sized silicon particles have better capability in accommodating the volume change of Si due to their larger specific surface area and higher average binding energy per atom at the surface. These materials can thus minimize the stress on them over volume change and avoid cracking or pulverization of their structures and reduce irreversible capacity and enhance cycling stability.

Furthermore, the surrounding environment, the chemical properties, surface properties and morphology of silicon particles can affect the mechanical stability, agglomeration, processing, and electrochemical properties of the silicon particles.

Accordingly, improved methods for controlling, selecting, modifying, or improving the surface properties and morphology of electroactive materials, e.g., silicon, is needed.

### SUMMARY

To obviate or mitigate at least one disadvantage of previous methods and materials for improving performance of high-capacity batteries, such as, e.g., lithium-ion batteries (e.g., cycling stability, battery lifetime), the present technology provides a composite material comprising void space (e.g., mega pores). The composite material provided herein further comprises optional silicon particles and a three-dimensional carbon network, wherein the at least some of the mega pores are formed by carbonizing a plurality of sacrificial particles dispersed throughout a three-dimensional network.

In one aspect, the composite materials described herein comprising mega pores and a three-dimensional carbon network are also useful as a substrate for chemical vapor deposition of silicon. In some embodiments, the composite materials comprise mega pores, a three-dimensional carbon network and a thin film including silicon, wherein the thin film partially or completely covers the surface of the mega pores and wherein the mega pores are distributed throughout the three-dimensional network.

In another aspect, the plurality of mega pores of the present technology, provides several advantages, including providing space to accommodate volume expansion of silicon particles during charging processes and stabilizing the composite material. Without wishing to be bound by theory, accommodating volume expansion of silicon particles may delay fracturing of silicon particles due to continuous charging and discharging battery cycles. The mega pores can function as “absorber” to accommodate the strain and stress in the entire electrode structure due to the Si volume change. That is, the existence of mega pores may reserve space for silicon (particles) during volume expansion and buffer the mechanical pressure of the three-dimensional carbon network, resulting in significantly enhanced structural integrity.

In one aspect, without wishing to be bound by theory, the composite materials of the present technology comprising mega pores may sustain the overall electrode integrity in terms of microscopic structure and electrical connectivity between Si particles (even pulverized) and current collector.

Mega pores which sufficiently accommodate the volume expansion of the silicon particles provide not only free space for volume expansion accommodation but also serve as efficient channels for Li⁺ diffusion and the charge transfer kinetic thus improving battery power.

In one aspect, the materials provided in the present disclosure may advantageously prevent or mitigate rapid capacity fading (e.g., within at least 10 cycles) of high-capacity batteries.

The composite materials of the present technology can improve the performance of lithium-ion batteries, relative to lithium-ion batteries having electrodes which do not possess the composite material of the present disclosure e.g., composite materials without voids.

Provided herein is a composite material comprising mega pores, the composite material further comprising: a three-dimensional carbon network and silicon particles dispersed throughout the three-dimensional carbon network. In some embodiments, the mega pores have an internal diameter in a range from about 50 nm to about 1000 nm. The mega pores surround or encompass the silicon particles providing separation or space to accommodate “breathing” of the silicon. At least some of the mega pores of the composite material disclosed herein is formed by carbonizing a plurality of sacrificial particles dispersed throughout a three-dimensional network.

In some embodiments, the three-dimensional carbon network comprises a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof.

In some embodiments, the three-dimensional carbon network is in the form of a bead. In some embodiments, the bead is substantially spherical, having a diameter from about 100 nm to about 4 mm, or from about 5 μm to about 4 mm.

In some embodiments, the composite material of the present technology is in monolithic form, in the form of thin sheets, or in particulate form.

In one aspect, provided herein is a composite material comprising a three-dimensional network; and sacrificial particles, wherein the sacrificial particles are dispersed throughout the three-dimensional network. In preferred embodiments, the composite material further comprising silicon particles, wherein the silicon particles are dispersed throughout the three-dimensional network.

In another aspect, provided herein is a composite material comprising mega pores, the composite material further comprising a three-dimensional network, wherein at least some of the mega pores are formed by carbonizing a plurality of sacrificial particles dispersed throughout a three-dimensional network.

In another aspect, the present technology provides a composite material comprising mega pores, the composite material further comprising a three-dimensional network; and silicon particles, wherein the silicon particles are dispersed throughout the three-dimensional network and at least some of the mega pores are formed by carbonizing a plurality of sacrificial particles dispersed throughout a three-dimensional network. In some embodiments, the mega pores are distributed throughout the three-dimensional network. In some embodiments, the mega pores are heterogeneously distributed throughout the three-dimensional network. In some embodiments, the mega pores are homogenously distributed throughout the three-dimensional network.

Provided herein is a mixture for forming a suspension, the mixture comprising: a. a sol-gel composition, wherein sol-gel composition is an aerogel precursor, a xerogel precursor, an ambigel precursor, an aerogel-xerogel hybrid material precursor, an aerogel-ambigel hybrid material precursor, an aerogel-ambigel-xerogel hybrid material precursor, or combinations thereof; and b. sacrificial particles, wherein the sacrificial particles are dispersed throughout the sol-gel composition. In preferred embodiments, the mixture for forming a suspension further comprise silicon particles, wherein the silicon particles are dispersed throughout the sol-gel composition.

In some embodiments, the surface of the silicon particles comprises covalently attached functional groups. In exemplary embodiments, covalently attached functional groups are formed from molecules selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof.

In some embodiments, the silicon particles are dispersed heterogeneously throughout the sol-gel composition. In some embodiments, the surface of the sacrificial particles is modified with hydrophilic moieties. In some embodiments, the sacrificial particles are cross-linked to a cross-linking agent. In some embodiments, the cross-linked sacrificial particles further comprise hydrophilic moieties (e.g., a polymer modifier) on the surface of the sacrificial particles.

In some embodiments, less than about 20 wt % of the dispersed silicon particles are in an agglomerated state.

In some embodiments, the sol-gel composition comprises a polyimide precursor.

In some embodiments, the sacrificial particles have a particle size in a range from about 50 nm to about 900 nm, from about 150 nm to about 900 nm, from about 150 nm to about 800 nm, from about 200 nm to about 600 nm. In one embodiment, the sacrificial particles have a particle size of 200 nm.

In some embodiments, the sacrificial particles have a particle size in a range from about 20 nm to about 300 nm, from about 20 nm to about 150 nm, from about 50 nm to about 150 nm, from about 50 nm to about 100 nm.

In some embodiments, the silicon particles have a particle size in a range from about 50 nm to about 1000 nm, from about 50 nm to 800 nm, from about 100 nm to 800 nm, from about 200 nm to 800 nm, from about 200 nm to 600 nm. In exemplary embodiment, the silicon particles have a particle size of 800 nm.

In some embodiments, a ratio of the total mass of the silicon particles to the total mass of the sacrificial particles is, between 1:0.5 to 1:2, between 1:0.5 to 1:1.5, between 1:1 to 1:1.5. In one embodiment, the total mass of the silicon particles to the total mass of the sacrificial particles is 1:1.

In some embodiments, the sacrificial particles comprise a polymer having a pyrolysis yield of less than 30 wt %, less than 20 wt %, less than 18 wt %, less than 15 wt %, less than 10 wt %, less than 8.0 wt %, or less than 5.0 wt %.

In some embodiments, the sacrificial particles are formed from a material selected from polymethylmethacrylate (PMMA), polyvinylpyrrolidone (PVP), polyvinyl acetate PVAc), polyvinyl alcohol (PVA), polyacrylonitrile (PAN), polyethylene oxide (PEO), polypropylene oxide (PPO), polyethyleneimine (PEI), polyurethane, poly(3,4-ethylenedioxythiophene, PEDOT), polyvinylbutyral, polyethylene oxide copolymer, polypropylene oxide copolymer, polycarbonate (PC), polyvinylchloride (PVC), polycaprolactone, polyvinylidene fluoride, polystyrene or combination thereof.

In some embodiments, the sacrificial particles comprise poly(styrene), poly(ester), poly(methacrylate), poly(acrylate), poly(ethylene glycol), poly(acid amides), poly(norbornene), or combination thereof. In one embodiment, the sacrificial particles comprise poly(methyl methacrylate).

In one aspect, provided herein is a composite material comprising: a. a three-dimensional network; and b. sacrificial particles, wherein the sacrificial particles are dispersed throughout the three-dimensional network. In preferred embodiments, the composite material further comprising silicon particles, wherein the silicon particles are dispersed throughout the three-dimensional network.

In some embodiments, the three-dimensional network comprises an aerogel, a xerogel, an ambigel, an aerogel-xerogel hybrid material, an aerogel-ambigel hybrid material, an aerogel-ambigel-xerogel hybrid material, or combinations thereof. In one embodiment, the three-dimensional network comprises a polyimide-derived aerogel.

In some embodiments, the total volume of the sacrificial particles is, less than four times, less than three times, or less than two times of the total volume of the silicon particles.

In some embodiments, the diameter of sacrificial particles is, at least 2.0 times greater, at least 1.8 times greater, at least 1.6 times greater, at least 1.2 times greater, or at least 1.1 times greater than the diameter of silicon particles.

In some embodiments, the three-dimensional network comprises from about 40% to about 80% by weight of the sacrificial particles, based on the total weight of the three-dimensional network.

In some embodiments, the three-dimensional network has a porosity between about 10% and about 90%, between about 20% and about 80%, or between about 10% and about 70%.

In some embodiments, the three-dimensional network has a pore volume of about more than about 0.3 cc/g and less than about 2.5 cc/g.

In one aspect, the present technology provides a composite material comprising mega pores obtained via pyrolyzing the composite material according to any one of the above aspects or embodiments.

In some embodiments, pyrolyzing the three-dimensional network carbonizes the sacrificial particles. In some embodiments, carbonizing the sacrificial particles result in formation of at least some of the mega pores. In some embodiments, the mega pores have an internal diameter (e.g., pore diameter) in a range from about 20 nm to about 900 nm, from about 50 nm to about 900 nm, from about 50 nm to about 600 nm, from about 50 nm to about 500 nm, from about 50 nm to about 500 nm.

In some embodiments, the mega pores have an internal diameter in a range from about 50 nm to about 1000 nm.

In some embodiments, the total volume of the mega pores is less than four times, or less than three times of the total volume of the plurality of silicon particles.

In some embodiments, the composite material has a porosity between about 50% and about 90%.

In another aspect, provided herein is a composite material comprising mega pores, and further comprising: a. a three-dimensional carbon network; and b. silicon particles, wherein the silicon particles are dispersed throughout the three-dimensional carbon network, wherein the mega pores have an internal diameter in a range from about 50 nm to about 400 nm. In some embodiments, the composite material has a porosity between about 50% and about 90%. In some embodiments, at least some of the mega pores are formed by carbonizing a plurality of sacrificial particles dispersed throughout a three-dimensional network.

In some embodiments, the three-dimensional network comprises an aerogel, a xerogel, an ambigel, an aerogel-xerogel hybrid material, an aerogel-ambigel hybrid material, an aerogel-ambigel-xerogel hybrid material, or combinations thereof. In one embodiment, the three-dimensional network comprises an aerogel comprising a polyimide or derived from a polyimide (e.g., a carbonized polyimide).

In one aspect, provided herein is an energy storage system comprising the composite material in accordance with the present technology. In some embodiments, the energy storage system is a battery. In one embodiment, the battery is a rechargeable battery. In another embodiment, the rechargeable battery is Li-ion battery.

In another aspect, provided herein is a rechargeable battery comprising the composite material in accordance with the present technology.

In another aspect, provided herein is a method of preparing a composite material comprising mega pores, the method comprising: a. providing silicon particles and sacrificial particles; b. optionally functionalizing the surface of the silicon particles; c. optionally crosslinking the sacrificial particles and optionally functionalizing the surface of the sacrificial particles to increase hydrophilicity; d. providing a sol-gel solution, the sol-gel solution comprising a polar solvent and a precursor of a three-dimensional network; e. processing the silicon particles and the sacrificial particles in the presence of the sol-gel solution to yield the three-dimensional network comprising the silicon particles and the sacrificial particles dispersed throughout the three-dimensional network; and f. pyrolyzing the three-dimensional network comprising the silicon particles and the sacrificial particles dispersed throughout the three-dimensional network to obtain the composite material, the composite material comprising mega pores.

In some embodiments, the method of preparing the composite material further comprises a step of subcritical or supercritical drying after processing the silicon particles and the sacrificial particles in the presence of the sol-gel solution and before pyrolyzing the three-dimensional network. In some embodiments, the three-dimensional network comprises an aerogel, a xerogel, an ambigel, an aerogel-xerogel hybrid material, an aerogel-ambigel hybrid material, an aerogel-ambigel-xerogel hybrid material, or combinations thereof. In one embodiment, the three-dimensional network comprises a polyimide derivative.

In some embodiment, the composite material has a pore volume of more than about 1.5 cc/g and less than about 6.0 cc/g.

In some embodiments, a ratio of the total mass of the sacrificial particles to the total mass of the precursor of the three-dimensional network is between about 10% and about 70%, or between about 10% and about 50%.

In some embodiments, the pyrolyzed three-dimensional network comprises a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof.

In one aspect, provided herein is a composite material comprising mega pores formed by the method of preparing the composite material in accordance with the present technology.

In another aspect, provided herein is a method of preparing a composite material comprising mega pores, the method comprising: a. providing sacrificial particles; b. optionally crosslinking the sacrificial particles and optionally functionalizing the surface of the sacrificial particles; d. providing a sol-gel solution, the sol-gel solution comprising a polar solvent and a precursor of a three-dimensional network; e. processing (e.g. gelation process) the sacrificial particles in the presence of the sol-gel solution to yield the three-dimensional network comprising the sacrificial particles dispersed throughout the three-dimensional network; and f. pyrolyzing the three-dimensional network comprising the sacrificial particles dispersed throughout the three-dimensional network to obtain the composite material, the composite material comprising mega pores. In some embodiments, the method further comprising a step of subcritical or supercritical drying after processing the sacrificial particles in the presence of the sol-gel solution and before pyrolyzing the three-dimensional network.

In some embodiments, the three-dimensional network comprises an aerogel, a xerogel, an ambigel, an aerogel-xerogel hybrid material, an aerogel-ambigel hybrid material, an aerogel-ambigel-xerogel hybrid material, or combinations thereof. In one embodiment, the three-dimensional network comprises a polyimide derivative. In some embodiments, the composite material has a pore volume of about more than about 1.5 cc/g and less than about 6.0 cc/g.

In some embodiments, a ratio of the total mass of the sacrificial particles to the total mass of the precursor of the three-dimensional network is between about 10% and about 50%.

In some embodiments, the pyrolyzed three-dimensional network comprises a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof.

In another aspect, provided herein is a composite material comprising mega pores formed by the method of preparing the composite material in accordance with the present technology, wherein the composite material comprises a three-dimensional carbon network and optional silicon particles, wherein the silicon particles are dispersed throughout the three-dimensional network and at least some of the mega pores are formed by carbonizing a plurality of sacrificial particles dispersed throughout a three-dimensional network.

Provided herein is a composite material comprising mega pores further comprising optional silicon particles, the composite material obtainable by any one of the methods described in accordance with the present technology.

In some embodiments, the volume of the mega pores is between 1% to 80%, 1% to 70%, 1% to 60%, 1% to 50%, 1% to 40%, 1% to 30%, 1% to 20%, 3% to 80, % 3% to 60%, 3% to 40%, 3% to 40%, 3% to 30%, 3% to 20, 3% to 10%, 3% to 20%, 3% to 50%, 3% to 100%, 3% to 200%, 3% to 250%, 5% to 50%, 5% to 40%, 5% to 20%, 5% to 15%, 10% to 20%, 20% to 40%, 20% to 50%, 20% to 60%, or 20% to 80% of the volume of the three dimensional carbon network. In some embodiments, the volume of mega pores is controlled by a ratio of the total mass of the silicon particles to the total mass of the sacrificial particles. The present technology provides the advantage of designing in void space (e.g., mega pores) the volume of which can be controlled. In some embodiments, the void space is designed by controlling the number of and/or distribution of and/or mass of, and/or diameter of sacrificial particles.

In another aspect, provided herein is a method of improving the performance of an energy storage system. The methods include incorporating the composite material in accordance with the present disclosure.

The composite materials provided herein are also useful as a substrate for chemical vapor deposition of silicon. In some embodiments, the composite material in accordance with the present disclosure may be incorporated into an energy storage system after vapor deposition (e.g., chemical vapor deposition) of silicon into the composite material.

### BRIEF DESCRIPTION OF THE DRAWINGS

The technology will be more fully understood from the following detailed description taken in conjunction with the accompanying drawings. It should be noted that the relative sizes in the drawings are not necessarily scaled but are shown for explanation purposes only.

FIG. 1A and FIG. 1B illustrate an exemplary composite material comprising mega pores in accordance with the present disclosure.

FIG. 2A and FIG. 2B illustrate exemplary composite materials according to certain aspects of the present technology and a method of treating the composite materials to obtain composite materials comprising mega pores.

FIG. 3 illustrates the steps of the method of preparing an exemplary composite material according to multiple embodiments of the present disclosure.

### DETAILED DESCRIPTION

Silicon (Si) is considered to be a promising alternative LIB anode material. It forms Li₇Si₃, Li₁₂Si₇, Li₁₃Si₄, Li₁₅Si₄, and Li₂₂Si₅ silicon-lithium alloys during the alloying process, among which LiisSi4 has a capacity of 3579 mAh g⁻¹ (2194 Ah L⁻¹) at room temperature, which is the highest theoretical capacity known for the anode material. Therefore, incorporating as much silicon as possible within the anode is desirable.

At the same time, the average voltage platform of Si (0.4 V vs. Li/Li⁺) is higher than that of the graphite electrode (0.125 V vs. Li/Li⁺), which makes it possible to avoid lithium plating and dendritic lithium formation on the anode material surface during the lithiation process. As a result, the safety performance of the battery can be significantly improved. Also, Si has the advantages of abundant reserves in the earth's crust and low price, which fosters further the industrial interest to utilize silicon in batteries.

Despite these advantages, silicon still has severe shortcomings when used as an electrode material. The core problem for the utilization of Si in a LIB is its vast volume expansion during lithiation. Si electrode can expand by up to 400%, which is much more than 10% for the graphite electrode. First, Si particles are gradually pulverized due to the repeated volume change and lose electrical contact between the active and other components, including conductive carbon and binder, which causes the capacity to decrease sharply and the cycle performance to decline rapidly. Secondly, the volume change also gradually causes active material to peel off the current collector, resulting in an electrical contact loss between the active material and the current collector, and the electrode capacity reduction after the initial cycle. Besides, the solid electrolyte interphase (SEI) layer is fractured and reformed continuously due to the volume expansion/contraction behavior of the Si electrode during cycling, resulting in the continuous exposure of fresh Si surface to the electrolyte. As a result, electrolyte degradation takes place continually on the highly reducing fresh lithiated Si surface, thus leading to an irreversible capacity loss at each cycle and eventual cell death. Both the mechanical failure and the electrolyte degradation can make the Si electrode lose its electrochemical activity very rapidly in the cycling process.

The composite materials provided herein obviate or mitigate at least one disadvantage of Si when used as an electrode material. Without wishing to be bound by theory, in general, the composite materials provided herein may be able to accommodate changes in volume of the active Si material during battery operation. In general, composite materials of the present technology include tailored or designed mega pores that accommodates changes in the volume of silicon or silicon particles incorporated within the composite material.

In the description below, several examples are provided in the context of aqueous Li-ion batteries because of the current prevalence and popularity of Li-ion technology. However, it will be appreciated that such examples are provided merely to aid in the understanding and illustration of the underlying techniques, and that these techniques may be similarly applied to various other metal-ion batteries, such as Li⁺, Na⁺, Mg²⁺, Ca²⁺, and Al³⁺, and other aqueous metal-ion batteries. The composite material of the present disclosure can be used in other battery chemistries where active particles undergo significant volume changes during their operation (e.g., reversible reduction-oxidation reactions), including, for example, aqueous electrolyte-containing batteries.

### Definitions

The articles “a” and “an” are used herein to refer to one or to more than one (i.e., to at least one) of the grammatical object of the article.

Within the context of the present disclosure, the term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the term “aerogel” or “aerogel material” refers to a solid object, irrespective of shape or size, comprising a framework of interconnected solid structures, with a corresponding network of interconnected pores integrated within the framework, and containing gases such as air as a dispersed interstitial medium. As such, aerogels such as carbon aerogels of the present application are open non-fluid colloidal or polymer networks that are expanded throughout their whole volume by a gas. Aerogels e.g., carbon aerogels are generally prepared by removing the solvent from a gel (a solid network that contains a solvent) in a manner such that minimal or no contraction of the gel can be brought by capillary forces at its pore walls, in other words, by the removal of all swelling agents from a corresponding wet-gel without substantial volume reduction or network compaction. Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that is subsequently transformed to the supercritical state, sub- or near-critical fluid drying, and sublimating a frozen solvent in a freeze-drying process. See for example, PCT Patent Application Publication No. WO2016127084A1.

Aerogels such as carbon-aerogels include a highly porous network of micro-, meso-, and macro-sized pores, and are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a specific surface area of about 100 m²/g or more, such as from about 100 to about 1000 m²/g by nitrogen sorption analysis.

Aerogel materials of the present disclosure thus include any aerogels or other open-celled compounds, which satisfy the defining elements set forth in previous paragraphs.

As used herein, the terms “xerogel” and “ambigel” refer to gels comprising an open, non-fluid colloidal or polymer network that is formed by the removal of all swelling agents from a corresponding wet-gel without any precautions taken to avoid substantial volume reduction or compaction, such as under ambient pressure drying. In contrast to an aerogel e.g. a carbon aerogel, a xerogel, such as a carbon xerogel, generally comprises a compact structure. Xerogels experience substantial volume reduction during ambient pressure drying, and can have lower surface areas compared to aerogels, such as 0-100 m²/g, or from about 0 to about 20 m²/g as measured by nitrogen sorption analysis.

Within the context of the present disclosure, the term “continuous” refers to a layer free of gaps, holes, or any discontinuities. For example, a continuous layer that does not include two (or more) component materials physically separated (or spaced apart) within this layer.

As used herein, the term “uniform” refers to a variation in the thickness of a material e.g., the coating of the present disclosure of less than about 10%, less than about 5%, or less than about 1%.

Within the context of the present disclosure, the term “capacity” refers to the amount of specific energy or charge that a battery is able to store. Capacity is specifically measured as the discharge current that the battery can deliver over time, per unit mass. It is typically provided as Ampere-hours or milliAmpere-hours per gram (Ah/g or mAh/g) of total active material mass. For example, a battery with 1 Ah capacity can supply a current of one ampere for one hour or 0.5 amps for two hours, etc. Therefore, 1 Ampere-hour (Ah) is the equivalent of 3,600 coulombs of electrical charge. Similarly, the term “milliampere-hour (mAh)” also refers to a unit of the storage capacity of a battery and is 1/1,000 of an Ampere-hour. The capacity of a battery (and an anode in particular) may be determined by methods known in the art, for example including, but not limited to: applying a fixed constant current load to a fully charged cell until the cell's voltage reaches the end of discharge voltage value; the time to reach end of discharge voltage multiplied by the constant current is the discharge capacity; by dividing the discharge capacity by the weight of electrode material or volume. Within the context of the present disclosure, measurements of capacity are acquired according to this method, unless otherwise stated. Unless otherwise noted, capacity is reported at cycle 10 of the battery.

As used herein, the term “electrode” refers to a “cathode” or an “anode.” As used herein, the term “positive electrode” is used interchangeably with cathode. Likewise, the term “negative electrode” is used interchangeably with anode.

Within the context of the present disclosure, the term “dispersion” refers to a dispersion in which one substance, which is the dispersed phase, is distributed in discrete units throughout the second substance (continuous phase or medium). In general, the dispersed phase is not substantially agglomerated, but rather spaced within the second substance. While dispersion includes the gathering or touching of a few particles (e.g., two, three, four, less than five), the particles are generally spaced evenly throughout the second substance.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 Angstroms. However, framework structures of the present disclosure can also include networks of interconnected oligomers, polymers, or colloidal particles of all diameter sizes that form the solid structure within a gel or aerogel.

Within the context of the present disclosure, the term “pyrolyze” or “pyrolysis” or “carbonization” refers to the decomposition or transformation of an organic compound or composition to pure or substantially pure carbon caused by heat. In the examples, the term “carbonization yield” refers to a percentage ratio of the weight of the resultant carbon to the weight of the organic compound or composition from which the carbon is produced.

### The Composite Material

In one aspect, the composite materials provided herein delivers high lithium storage capacity with improved cyclability.

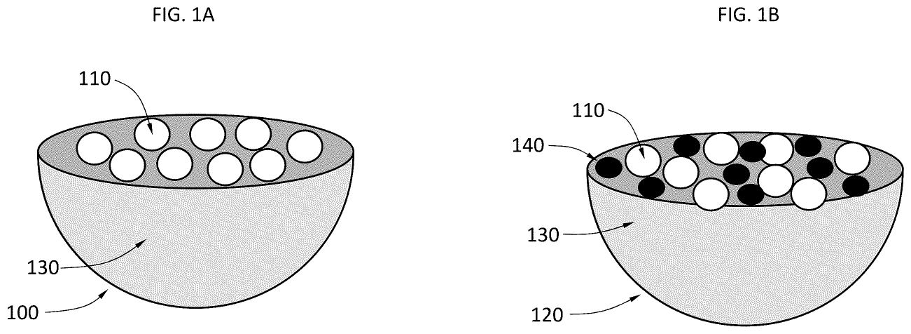

FIGS. 1A and 1B illustrate an exemplary composite material of the present disclosure comprising mega pores. Referring to FIG. 1A, in one aspect provided herein is a composite material 100 comprising void space 110 (e.g., mega pores 110) and a three-dimensional carbon network 130. The three-dimensional carbon network 130 may include a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof.

Referring to FIG. 1B, in one aspect provided herein is a composite material 120 comprising mega pores 110, the composite material further comprising a three-dimensional carbon network; and silicon particles 140, wherein the silicon particles 140 are dispersed throughout the three-dimensional carbon network 130 and at least some of the mega pores 110 are formed by carbonizing a plurality of sacrificial particles 160 dispersed throughout a three-dimensional network 150. The mega pores may at least partially surround or encompass the silicon particles, and as a result are able to accommodate volumetric changes in the silicon particles.

Generally, the silicon is contained at least partially within the pores of the porous network, i.e., the silicon is disposed within the framework of the porous network. The silicon accepts lithium ions during charge and releases lithium ions during discharge. In certain embodiments, the porous network forms interconnected structures around the silicon, which is connected to the porous network at a plurality of points. In some embodiments, the three-dimensional network is a porous network.

In some embodiments, the three-dimensional network 150 comprises an aerogel, a xerogel, an ambigel, an aerogel-xerogel hybrid material, an aerogel-ambigel hybrid material, an aerogel-ambigel-xerogel hybrid material, or combinations thereof. In some embodiments, the three-dimensional carbon network 130 is in the form of a bead. In some embodiments, the bead is substantially spherical, having a diameter from about 100 nm to about 4 mm, or from about 5 μm to about 4 mm.

Within the context of the present disclosure, the term “mega pores” refer to a material comprising pores with a diameter between about 50 nm to about 1000 nm. The space used by the mega pores refer to the space that is “empty”, namely the space not utilized by the either silicon or the three-dimensional carbon network. The mega pores surround or encompass the silicon particles providing separation or space to accommodate “breathing” of the silicon. At least some of the mega pores of the composite material disclosed herein is formed by carbonizing a plurality of sacrificial particles dispersed throughout a three-dimensional network 150.

Although it is not shown in the figures for the illustration purposes, the three-dimensional carbon network and/or the three-dimensional network of the present disclosure may also include micro pores and/or meso pores.

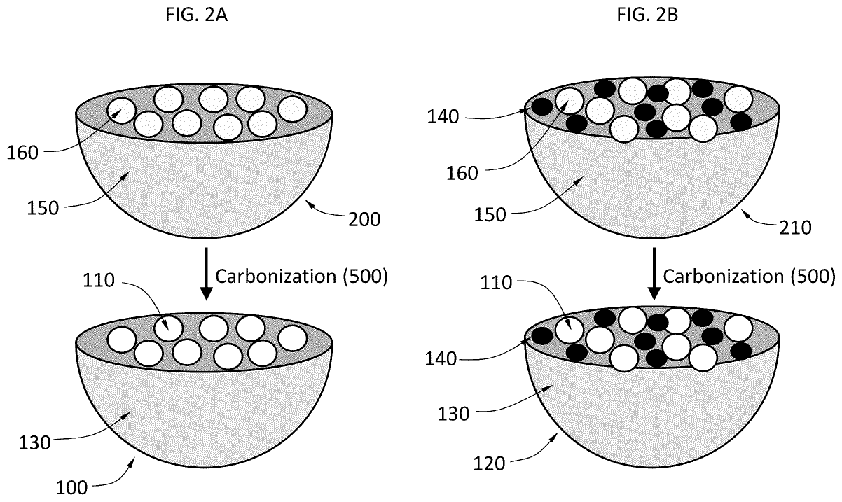

FIGS. 2A and 2B illustrate exemplary composite materials (200, 210, respectively) according to certain aspects of the present technology and a method 500 of treating the composite materials to obtain composite materials comprising mega pores. Referring to FIG. 2A, the composite material 200 comprises a three-dimensional network 150; and sacrificial particles, wherein the sacrificial particles 160 are dispersed throughout the three-dimensional network 150.

In some embodiments, the composite material of the present technology (110, 120, 200, 210) is in monolithic form, in the form of thin sheets, or in particulate form.

The sacrificial particles are typically provided from the same source and have a known, desired particle size, shape, porosity and other material attributes that are substantially similar. In some examples, the sacrificial particles have a diameter of less than 1000 nm, less than 800 nm, less than 500 nm, less than 300 nm, less than 250 nm, less than 200 nm, less than 150 nm or less than 100 nm.

The sacrificial particles may comprise polystyrene, polyester, polymethacrylate, polyacrylate, polyethylene glycol, polyacid amides, polynorbornene, or combination thereof. In one embodiment, the sacrificial particles comprise poly(methyl methacrylate) (PMMA). The sacrificial particles may not be substantially spherical. In some examples, the sacrificial particles may be substantially spherical.

Referring to FIG. 2B, the composite material 210 comprises a three-dimensional network 150; sacrificial particles 160 and silicon particles 140, wherein the sacrificial particles 160 and the silicon particles 140 are dispersed throughout the three-dimensional network 150.

In some examples, the silicon particles have a diameter of less than 1000 nm, less than 800 nm, less than 500 nm, less than 300 nm, less than 250 nm, less than 200 nm, less than 150 nm or less than 100 nm.

In order to obtain the composite materials (100 and 120) according to the certain aspect of this technology, the composite materials provided herein comprising sacrificial particles (200 and 210, respectively) undergo carbonization 500.

In some embodiments, the sacrificial particles have a carbonization 500 yield of less than about 20 wt %. In some embodiments, the temperature of chemical decomposition of the sacrificial particles is in the range of about 130° C. to about 850° C. The sacrificial particles can be made of polymers, metals, natural and synthetic organics, salts, ceramic compounds or combination thereof.

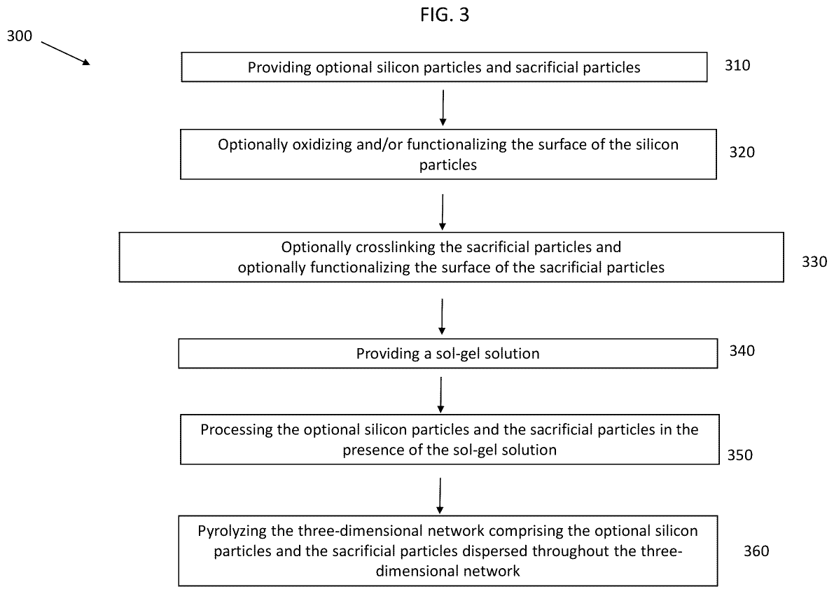

Referring to FIG. 3, method 300 illustrating the manufacture of a composite material according to multiple embodiments of the present disclosure includes six steps (310, 320, 330, 340, 350, 360). In this method 300, at least some of the mega pores are formed after pyrolyzing a three-dimensional network comprising optional silicon particles and sacrificial particles. First, as shown in step 310, optional silicon particles and sacrificial particles are provided. In general, the silicon particles should be homogenous. That is, the silicon particles are typically provided from the same source and have a known, desired particle size, shape, porosity and other material attributes that are substantially similar. The sacrificial particles may comprise materials having a carbonization yield less than 20%. The sacrificial particles may comprise polystyrene, polyester, polymethacrylate, polyacrylate, polyethylene glycol, polyacid amides, polynorbornene, or combination thereof. In case, the silicon particles are present, a ratio of the total mass of the silicon particles to the total mass of the sacrificial particles is between 1:0.5 to 1:2.

The method 300 includes optionally oxidizing and/or functionalizing the surface of the silicon particles to increase hydrophilicity of the silicon particles (i.e., step 320). Oxidizing the surface of silicon particles may lead to complete or partial oxidation of surface Si—H groups. That is, all or certain percentage of Si—H groups on the surface of the silicon particles are converted to Si—OH groups after oxidation process. The silicon particles may be oxidized in a single or multiple step(s). The oxidation can be thermal (e.g., at elevated temperatures under air), chemical (e.g., acid and/or oxidizing agent), electrochemical or combinations thereof. Functionalizing the surface of the silicon particles requires the silicon particles having hydroxyl functional groups on the surface thereof to covalently react with at least one functional silane group. Attachment of silane groups to the surface can pave the way for further modification of the silicon particles' surfaces. In addition, silane groups present on the surface of the silicon particles can aid the dispersion of the silicon particles which is crucial for further steps. The silicon particles may be functionalized with functional groups are formed from molecules selected from 3-aminopropyltriethoxysilane (APTES), 3-aminopropyltrimethoxysilane (APTMS), N-(2-aminoethyl)-3-aminopropyltricthoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof. The silicon particles may be dispersed in the sol-gel solution that will be provided in step 340 homogenously or heterogeneously, preferably homogenously. The sacrificial particles provided in step 310 may be optionally crosslinked to a cross-linking agent and optionally functionalized with a polymer modifier (e.g., hydrophilic moiety). A polymer modifier may help to increase hydrophilicity of the sacrificial particles. Then, in step 350, a sol-gel solution is provided. The sol-gel solution may include a polar solvent and a precursor of a three-dimensional network. A precursor of the porous three-dimensional network may be a precursor of an aerogel precursor, a xerogel precursor, an ambigel precursor, an aerogel-xerogel hybrid material precursor, an aerogel-ambigel hybrid material precursor, an aerogel-ambigel-xerogel hybrid material precursor, or combinations thereof. The polar solvent may include dimethylsulfoxide (DMSO), dimethylformamide (DMF), ethyl acetate, n-methyl pyrrolidone (NMP), dimethylacetamide (DMA), propylene carbonate, water, glycerin, propylene glycol, ethylene glycol, tetraethylene glycol, triethylene glycol and trimethylene glycol, or mixtures thereof. The selected polar solvent should be suitable for dissolving or suspending each component of the reaction, e.g., the polymer (initiator) (e.g., a precursor of three-dimensional network), the silicon particles.

As shown in step 350, the fifth step is to form a composite material comprising: a three-dimensional network; sacrificial particles, wherein the sacrificial particles are dispersed throughout the three-dimensional network; and optional silicon particles, wherein the silicon particles are dispersed throughout the three-dimensional network. Processing the optional silicon particles and the sacrificial particles in the presence of the sol-gel solution 350 can include gelation of the sol-gel solution to form the three-dimensional porous network. After formation of the three-dimensional porous network, the method may optionally include a step of subcritical or supercritical drying after processing the silicon particles in the presence of the sol-gel solution. For example, the drying step can lead to the formation of an aerogel, an xerogel, or hybrid thereof.

Step 360 includes pyrolyzing the three-dimensional network comprising the optional silicon particles and the sacrificial particles dispersed throughout the three-dimensional network. At least some of the mega pores may be formed due to carbonization of the sacrificial particles. In one embodiment, the amount of sacrificial particles that is removed depends on the duration of heat treatment, e.g. pyrolysis, applied to the porous network. In some embodiments, the pore size of mega pores depends on the amount of sacrificial particles that is removed by carbonization. For example, carbonization that takes place at higher temperature and/or longer duration may result in larger pore sizes of mega pores than the mega pores formed by the carbonization that takes place at lower temperature and/or shorter period of time.

In some embodiments, the chemical decomposition temperature of the sacrificial particles is in the range of about 130° C. to about 850° C. In certain embodiments, processing the composite material to partially or completely remove the sacrificial particles provides a void space (e.g., mega pores) around the silicon particles.

In some embodiments, the method of preparing a composite material further comprises step of subcritical or supercritical drying after processing the sol-gel solution. In some embodiments, a step of subcritical or supercritical drying after processing the sol-gel solution. In some embodiments, the step of subcritical or supercritical drying results in formation of aerogel materials e.g. xerogels, aerogels etc.

Oxidizing the surface of the silicon particles may comprise an acid treatment step. In some embodiments, the acid treatment step comprises the use of sulphochromic acid or H₂O₂ (hydrogen peroxide). In some examples, the acid treatment step comprises a step of sonicating the plurality of the silicon particles for a certain period of time, e.g., at least 5 minutes, at least 10 minutes, at least 20 minutes, at least 30 minutes, or at least 60 minutes. Oxidizing a surface of the plurality of the silicon particles may comprise a step of pyrolysis at a temperature about at 300, about 400, or about 500, to about 600, about 650, about 700, about 800, about 850, or about 900° C. In some embodiments, the temperature is about 650° C. As used herein, the term “pyrolyze” or “pyrolysis” refers to the decomposition or transformation of an organic compound or composition to pure or substantially pure carbon caused by heat. Oxidizing a surface of the plurality of the silicon particles may lead to decrease in the number of Si—H bonds on the surface of the silicon particles.

In some embodiments, the method of preparing a composite material of the present disclosure further comprises a step of subcritical or supercritical solvent removal, e.g., drying, after processing the plurality of silicon particles in the presence of the sol-gel solution (prior to or after pyrolysis step). Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that is subsequently transformed to the supercritical state, sub- or near-critical fluid drying, and sublimating a frozen solvent in a freeze-drying process. See for example, PCT Patent Application Publication No. WO2016127084A1.

The composite material may be in a variety of different physical forms. In some embodiments, the composite material can take the form of a monolith. As used herein, the term “monolith” refers to materials in which a majority (by weight) of the low-density skeletal framework included in the composite material is in the form of a unitary, continuous, self-supporting object. With reference to aerogel materials, monolithic aerogel materials include aerogel materials which are initially formed to have a well-defined shape, but which can be subsequently cracked, fractured or segmented into non-self-repeating objects. For example, irregular chunks may be considered as monoliths. Monolithic aerogels may take the form of a freestanding structure, or a reinforced material with fibers or an interpenetrating foam.

In other embodiments, the composite material may be in particulate form, for example as beads or as particles from, e.g., crushing a monolithic material. As used herein, the term “beads” is meant to include discrete small units or pieces having a generally spherical shape. In some embodiments, the composite material beads are substantially spherical.

The composite material in particulate form can have various particle sizes. In the case of spherical particles (e.g., beads), the particle size is the diameter of the particle. In the case of irregular particles, the term particle size refers to the maximum dimension (e.g., a length, width, or height). The particle size may vary depending on the physical form, preparation method, and any subsequent physical steps performed. In some embodiments, the composite material in particulate form can have a particle size from about 1 micrometer to about 1 millimeter. For example, the composite material in particulate form can have a particle size of about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, about 15 micrometers, about 20 micrometers, about 25 micrometers, about 30 micrometers, about 35 micrometers, about 40 micrometers, about 45 micrometers, about 50 micrometers, about 60 micrometers, about 70 micrometers, about 80 micrometers, about 90 micrometers, about 100 micrometers, about 200 micrometers, about 300 micrometers, about 400 micrometers, about 500 micrometers, about 600 micrometers, about 700 micrometers, about 800 micrometers, about 900 micrometers, about 1 millimeter, or in a range between any two of these values.

In some embodiments, the composite material has a particle size D90 value of less than or equal to 40 micrometers. In some embodiments, the composite material has a particle size D10 value of at least 1 micrometer. In some embodiments, the composite material has a particle size D50 in a range from about 5 micrometers to about 20 micrometers.

In some embodiments, the composite material of the present disclosure comprises a low bulk density material such as carbon-aerogels. In some embodiments, the low bulk density material comprises a skeletal framework comprising nanofibers, the skeletal framework forming a pore structure comprising an array of interconnected pores. In some embodiments, such materials may have a fibrillar morphology. In some embodiments, the composite material is a carbon aerogel, a carbon xerogel, a carbon cryogel, or a carbon ambigel, or combination thereof. In some embodiments, the composite material is an aerogel. In contrast to an aerogel, a xerogel, such as a silica xerogel, generally comprises a compact structure. Xerogels experience substantial volume reduction during ambient pressure drying, and can have lower surface areas compared to aerogels, such as 0-100 m²/g, or from about 0 to about 20 m²/g as measured by nitrogen sorption analysis. In addition, xerogels have a more densely packed fibrillar morphology compared to aerogels. Within the context of the present disclosure, the term “fibrillar morphology” refers to the structural morphology of a nanoporous material (e.g., a carbon aerogel) being inclusive of struts, rods, fibers, or filaments. Structurally, some embodiments of the carbon network have a fibrillar morphology with a strut size that produces the aforementioned narrow pore size distribution, porosity, and enhanced connectedness, among other properties. In any embodiment, the fibrillar morphology of the carbon network can include an average strut width of about 2-10 nm, or even more specifically about 2-5 nm.

Within the context of the present disclosure, the term “strut width” refers to the average diameter of nanostruts, nanorods, nanofibers, or nanofilaments that form a material having a fibrillar morphology. It is typically recorded as any unit length, for example micrometers or nm. The strut width may be determined by methods known in the art, for example including, but not limited to, scanning electron microscopy image analysis. Within the context of the present disclosure, measurements of strut width are acquired according to this method, unless otherwise stated. In certain embodiments, materials or compositions of the present disclosure have a strut width of about 10 nm or less, 9 nm or less, 8 nm or less, 7 nm or less, 6 nm or less, 5 nm or less, 4 nm or less, 3 nm or less, 2 nm or less, or in a range between any two of these values. An exemplary range of strut widths is about 2-5 nm. Smaller strut widths, such as these, permit a greater amount of struts to be present within the network and thus contact the electrochemically active species, in turn allowing more of the electrochemically active species to be present within the composite. This increases electrical conductivity and mechanical strength.

### Measurement of Composite Material Properties

The composite materials can be characterized by properties such as pore volume, porosity, surface area, and pore size distribution. These properties and associated terms are defined herein below, along with methods of measuring and/or calculating such properties.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It is typically recorded as cubic centimeters per gram (cm³/g or cc/g).

Within the context of the present disclosure, the term “porosity” when used with respect to the polymeric network or the composite materials disclosed herein, refers to a volumetric ratio of pores that does not contain another material (e.g., an electrochemically active species such as silicon particles) bonded to the walls of the pores. For clarification and illustration purposes, it should be noted that within the specific implementation of silicon-doped polymeric network e.g., an aerogel as the primary anodic material in a LIB, porosity refers to the void space after inclusion of silicon particles. As such, porosity may be, for example, about 10%-70% when the anode is in a pre-lithiated state (to accommodate for ion transport and silicon expansion) and about 1%-50% when the anode is in a post-lithiated state. It should be noted that pore volume and porosity are different measures for the same property of the pore structure, namely the “empty space” within the pore structure. For example, when silicon is used as the electrochemically active species contained within the pores of the polymeric network (e.g., a composite material as described herein), pore volume and porosity refer to the space that is “empty”, namely the space not utilized by the silicon or the carbon.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus optimizing the amount of pores that can surround the electrochemically active species and maximizing use of the pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It is typically recorded as any unit length of pore size, for example micrometers or nanometers (nm).

Within the context of the present disclosure, the term “BET surface area” has its usual meaning of referring to the Brunauer-Emmett-Teller method for determining surface area by N₂ adsorption measurements. The BET surface area, expressed in m²/g, is a measure of the total surface area of a porous material per unit of mass. Unless otherwise stated, “surface area” refers to BET surface area. As an alternative to BET surface area, a geometric outer surface area of e.g., a polyimide or carbon bead may be calculated based on the diameter of the bead. Generally, such geometric outer surface areas for beads of the present disclosure are within a range from about 3 to about 700 μm².

As used herein, the term “particle size D50” which is a volume-based accumulative 50% size which is a particle size at a point of 50% on an accumulative curve (i.e., a diameter of a particle in the 50th percentile (median) of the volumes of particles) when the accumulative curve is drawn so that a particle size distribution is obtained on the volume basis and the whole volume is 100%.

Within the context of the present disclosure, the term “density” refers to a measurement of the mass per unit volume of a material (e.g., a composite material as described herein). The term “density” generally refers to the true or skeletal density of a material, as well as to the bulk density of a material or composition. Density is typically reported as g/cm³, g/cc, or g/mL.

The composite material properties can be determined using mercury intrusion porosity and helium pycnometry experiments. Mercury intrusion porosity can be used to determine porosity, pore size distribution and pore volume to solid particles. During a typical mercury intrusion porosity, a pressurized chamber is used to force mercury into the voids in a porous substrate. As pressure is applied, mercury fills the larger pores first. As the pressure increases, the mercury can enter into smaller pores. The mercury pycnometry can access and measure pores greater than about 3 nm. Mercury intrusion porosity can be used measure bulk density, skeletal density and porosity. By varying testing parameters (e.g., the pressure range), pores with different sizes can be excluded. The lower pore size limit if mercury intrusion porosity is about 3 nm.

Helium pycnometry uses helium gas to measure the volume of pores of a solid material. During helium pycnometry, a sample is sealed in a compartment and helium gas is added to the compartment. The helium gas penetrates into small pores in the material. After the system has equilibrated, the change in pressure can be used to determine the skeletal density of the solid material. The Helium pycnometry can access and measure pores greater than about 0.3 nm, for example, pores sizing from about 3 nm to about 300 nm.

The “Hg skeletal density” (g/cm³) is measured by dividing the mass (g) of the composite material particles by the volume (cm³) of the particles, where the volume is measured by controlling (e.g., by pressure) the mercury access to pores of the particles greater than 3 nm during the measurement. This volume does not include the volume of the mercury accessible pores of the composite materials greater than 3 nm. Instead, the volume only includes the volume of the “skeleton” of the composite material particles. The volume of the pores less than 3 nm is considered as part of the skeleton and included in the skeletal density calculation.

The “Hg bulk density” is measured by dividing the mass (g) of the composite material particles by the volume (cm³) of the particles, where the volume is measured by controlling (e.g., by pressure) the mercury not to access pores of the particles during the measurement. This volume includes the volume of the pores of the composite materials, including pores greater than 3 nm and less than 3 nm.

The “He skeletal density” is measured by dividing the mass (g) of the composite material particles by the volume (cm³) of the particles, where the volume is measured by controlling (e.g., by pressure) the helium to access pores of the particles greater than 0.3 nm during the measurement. This volume does not include the volume of the helium accessible pores of the composite materials greater than 0.3 nm. Instead, the volume only includes the volume of the “skeleton” of the composite material particles. The volume of the pores less than 0.3 nm is considered as part of the skeleton and included in the skeletal density calculation.

The composite material may also include pores not accessible to either helium nor mercury during the helium pycnometry or mercury pycnometry tests. For example, some of pores formed by removing sacrificial particles may be enclosed in the three-dimensional network and therefore accessible to neither helium pycnometry nor the mercury pycnometry. These non-accessible pores are usually a very small amount in the composite materials disclosed herein. The non-accessible pores are treated as part of the volume of the skeleton without introducing significant variations.

Various physical properties can be calculated according to the formulas below using mercury (Hg) intrusion skeletal density measurements (Hg skeletal density) measured by mercury pycnometry, mercury intrusion bulk density (Hg bulk density) measured by mercury pycnometry, and helium (He) skeletal density (He skeletal density) tested by He pycnometry.

$$Total beads level porosity ( \% ) = \{ ( 1 - \frac{Hg bulk density}{He skeletal density} ) / 1 \} * 100 \qquad ( 1 )$$

$$Total pore volume ( {cm}^{3} / g ) = \frac{1}{Hg bulk density} * \frac{Total beads level porosity}{100} \qquad ( 2 )$$

$$Micropore volume ( {cm}^{3} / g ) = \frac{1}{Hg skeletal density} - \frac{1}{He skeletal density} \qquad ( 3 )$$

$$Micropore volume percentage ( \% , vs total pore volume ) = micropore volume / total pore volume \qquad ( 4 )$$

$$Mesopore volume percentage ( \% , vs total pore volume ) can be obtained through the mercury intrusion by excluding all the pores > 50 nm$$

$$Macropore volume percentage ( \% , vs total pore volume ) = 1 - micropore volume percentage - mesopore volume percentage \qquad ( 5 )$$

The “total beads level porosity” (%) refers to the ratio of the volume of the pores in the composite material particles to the volume of the composite material particles. The total beads level porosity is calculated by equation (1). The total beads level porosity includes pores of greater than 0.3 nm that can be accessed by helium and mercury.

The “total pore volume” (cm³/g) refers to the total pore volume of unit weight of the composite material particles. The total pore volume is calculated by equation (2). The total pore volume includes pores greater than 0.3 nm that can be accessed by helium and mercury.

The “micropore volume” (cm³/g) refers to the micropore volume of unit weight of the composite material particles. The micropore volume (cm³/g) of the composite material is the difference between of the reciprocal (cm³/g) of the mercury skeletal density (g/cm³) and the reciprocal (cm³/g) of the helium skeletal density (g/cm³) according to equation (3). The micropore volume includes pores greater than 0.3 nm but less than 3 nm. The micropores are accessible by helium but not accessible by mercury. Within the context of the present disclosure, the term “micropores” refers to pores with a diameter smaller than 3 nm, the term “mesopores” refers to pores with a diameter between 3 nm and 50 nm, and the term “macropores” refers to pores with a diameter greater than 50 nm.

The “micropore volume percentage” (%) refers to the volumetric ratio between the volume of the micropore to the total pore volume. The micropore volume percentage is calculated by equation (4).

The “mesopore volume percentage” (%) refers to the volumetric ratio between the volume of the mesopores to the total pore volume. Mesopores refers to pores between about 3 nm to about 50 nm that are accessible by mercury. Pores below 3 nm are not accessible by mercury. Mesopore volume percentage can be directly measured using mercury pycnometry by excluding pores greater than 50 nm. The mesopore volume percentage can also be obtained by subtracting micropore volume percentage (calculated in equation (4)) and macropore volume percentage (measured by mercury pycnometry) from total pore volume percentage (100%).

The “macropore volume percentage” (%) refers to the volumetric ratio between the volume of the macropores to the total pore volume. Macropores are greater than about 50 nm that are accessible by mercury. Macropore volume percentage can be directly measured using mercury pycnometry by excluding pores smaller than 50 nm. The macropore volume percentage can also be obtained by subtracting micropore volume percentage (calculated in equation (4)) and mesopore volume percentage (measured by mercury pycnometry) from total pore volume percentage (100%).

### Composite Material Properties

### Total Porosity

Composite materials described herein generally include micropores (<3 nm), mesopores (3 nm-50 nm), and macropores (>50 nm). The composite materials described herein include a three-dimensional carbon network having a substantial amount of macropores. In some aspects, the total level of porosity of the three-dimensional carbon network is greater than 10%, greater than 20%, greater than 30%, greater than 40%, greater than 50%, greater than 60%, or greater than 70%. In some aspects, the total level of porosity of the three-dimensional carbon network is 25% to 35%, 30% to 40%, 35% to 45%, 40% to 50%, 55% to 65%, or 60% to 70%.

In certain embodiments, aerogel materials e.g., carbon aerogel materials (carbon-based aerogel materials) or composite materials of the present disclosure have a total bead level porosity of about 80% or less, 70% or less, 60% or less, 50% or less, 40% or less, 30% or less, 20% or less, 10% or less, or in a range between any two of these values.

### Total Pore Volume

In some aspects, aerogel materials or compositions of the present disclosure (without incorporation of electrochemically active species, e.g., silicon) have a relatively large total pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, aerogel materials or compositions of the present disclosure (with incorporation of electrochemically active species, e.g., silicon) have a total pore volume of about 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values. In further aspects, the total pore volume of the composite material (with incorporation of electrochemically active species, e.g., silicon) is from about 0.1 cm³/g to about 1.5 cm³/g, about 0.1 cm³/g to about 1.0 cm³/g, about 0.1 cm³/g to about 0.5 cm³/g, about 0.1 cm³/g to about 0.4 cm³/g, about 0.4 cm³/g to about 1.0 cm³/g, or about 0.9 cm³/g to about 1.4 cm³/g.

### Pore Size Distribution

In certain embodiments, aerogel materials or compositions of the present disclosure have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

In certain embodiments, aerogel materials e.g. carbon-based aerogel materials or composite materials of the present disclosure have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

In certain embodiments, aerogel materials e.g., carbon-based aerogel materials may have a relatively narrow pore size distribution (full width at half max) of about 150 nm or less, about 100 nm or less, about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

In a particular embodiment, the composite materials according to certain aspects of the present technology possess a bimodal pore size distribution comprised of a first mode of pores and a second mode of pores. Preferably, the first mode of pores has a mean pore diameter ranging from about 50 nm to about 1000 nm and the second mode of pores has a mean pore diameter ranging from about less than 3 nm.

In a particular embodiment, the composite materials according to certain aspects of the present technology possesses a multimodal pore size distribution comprised of a first mode of pores, a second mode of pores, and a third mode of pores. Preferably, the first mode of pores has a mean pore diameter ranging from about 50 nm to about 1000 nm, the second mode of pores has a mean pore diameter ranging from about 3 nm to about 50 nm and the third mode of pores has a mean pore diameter less than 3 nm.

### Macropores, Mesopores, and Micropores

In some aspects, the macropores constitute a volume fraction of greater than about 5%, greater than about 10%, greater than about 20%, greater than about 30%, greater than about 40%, greater than about 50%, greater than about 60%, greater than about 70%, or greater than about 80% of the total pore volume of the three-dimensional carbon network. In some aspects, the macropores constitute a volume fraction of 45% to 55%, 55% to 65%, 65% to 75%, or 70% to 80% of the total pore volume of the three-dimensional carbon network. The composite materials described herein generally have a low volume fraction of mesopores. In some aspects, the mesopores constitute a volume fraction of less than 20%, less than 10%, less than 5%, less than 2%, or less than 1% of the total pore volume of the three-dimensional carbon network. In some aspects, the mesopores constitute a volume fraction of 10% to 20%, 5% to 10%, or 1% to 5% of the total pore volume of the three-dimensional carbon network.

The composite materials described herein include a higher percentage of micropores compared to mesopores. In some aspects, the micropores constitute a volume fraction of less than 80%, less than 70%, less than 65%, less than 55%, less than 50%, less than 45%, less than 40%, less than 35%, less than 30%, less than 25%, less than 20%, less than 15%, or less than 10% of the total pore volume of the three-dimensional carbon network. In some aspects, the micropores constitute a volume fraction of about 10% to about 50%, about 10% to about 45%, about 10% to about 40%, about 10% to about 35%; about 10% to about 30%, about 10% to about 25%, about 10% to about 20%, about 10% to about 15%, about 15% to about 25%, about 25% to about 35%, about 35% to about 45%, or about 45% to about 55% of the total pore volume of the three-dimensional carbon network.

### Skeletal Density

In some aspects, the composite materials have a skeletal density, measured using helium pycnometry, of about 1.0 g/mL to about 2.5 g/mL, about 1.5 g/mL to about 2.5 g/mL, about 1.0 g/mL to about 2.0 g/mL, or 1.0 g/mL to about 1.5 g/mL. In some aspects, the composite materials have a skeletal density, measured using mercury intrusion, of about 0.5 g/mL to about 2.5 g/mL, about 1.5 g/mL to about 2.5 g/mL, about 1.5 g/mL to about 2.0 g/mL, about 0.5 g/mL to about 2.0 g/mL, about 0.5 g/mL to about 1.5 g/mL, or about 0.5 g/mL to about 1.0 g/mL. In some aspects, the composite materials have a bulk density, measured using mercury pycnometry, of 0.5 g/mL to about 2.5 g/mL, of 0.5 g/mL to about 2.0 g/mL, about 0.5 g/mL to about 1.5 g/mL, or about 0.5 g/mL to about 1.0 g/mL.

The tap density of the composite material may vary. In some embodiments, the composite material has a tap density in a range from about 0.15 g/cm³ to about 1.2 g/cm³.

The surface area of the composite material may vary. For example, the surface area may be up to about 100 m²/g, or may be greater than 100 m²/g. In some embodiments, the composite material has a surface area in a range from about 1 m²/g to about 400 m²/g, such as from about 1, about 10, or about 50, to about 100, about 200, about 300, or about 400 m²/g.

In some embodiments, the composite material comprises silicon in an amount by weight from about 20 to about 85%, such as from about 20, about 25, about 30, about 35, about 40, about 45, or about 50, to about 55, about 60, about 65, about 70, about 75, about 80, or about 85% silicon by weight, based on the total weight of the composite material.

The composite material may be in a variety of different physical forms. In some embodiments, the composite material can take the form of a monolith. As used herein, the term “monolith” refers to materials in which a majority (by weight) of the low-density skeletal framework included in the composite material is in the form of a unitary, continuous, self-supporting object. With reference to aerogel materials, monolithic aerogel materials include aerogel materials which are initially formed to have a well-defined shape, but which can be subsequently cracked, fractured or segmented into non-self-repeating objects. For example, irregular chunks may be considered as monoliths. Monolithic aerogels may take the form of a freestanding structure, or a reinforced material with fibers or an interpenetrating foam.

In other embodiments, the composite material may be in particulate form, for example as beads or as particles from, e.g., crushing a monolithic material. As used herein, the term “beads” is meant to include discrete small units or pieces having a generally spherical shape. In some embodiments, the carbon-silicon composite beads are substantially spherical.

The capacity of the composite material may vary. In some embodiments, the composite material has a specific capacity of at least about 400 mAh/g. In some embodiments, the composite material has a specific capacity of about 400, about 500, about 600, about 700, about 800, about 900, about 1000, or about 1100 mAh/g. In some embodiments, the composite material has a specific capacity of 1200 mAh/g or more, 1400 mAh/g or more, 1600 mAh/g or more, 1800 mAh/g or more, 2000 mAh/g or more, 2400 mAh/g or more, 2800 mAh/g or more, 3200 mAh/g or more, or in a range between any two of these values.

The electrical conductivity of the anode material may vary. Within the context of the present disclosure, the term “electrical conductivity” refers to a measurement of the ability of a material to conduct an electric current or other allow the flow of electrons there through or therein. Electrical conductivity is specifically as measured the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84-resistivity (R) measurements obtained by measuring voltage (V) divided by current (I), unless otherwise stated. In certain embodiments, anode materials of the present disclosure have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

### The Three-Dimensional Carbon Network

The three-dimensional carbon network of the present disclosure comprises a carbon-based network selected from a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof.

The aerogels used in the present disclosure may be carbonized to obtain the three-dimensional carbon network e.g., carbon-based aerogel of this present technology. Carbonization may be carried out by pyrolysis at elevated temperatures in an inert atmosphere.

The carbonized forms of the aerogels used in the present disclosure may have the nitrogen content between 0 and 20%. Typical pyrolysis temperatures range is between 500° C. and 2000° C. Temperature may be increased to reduce the nitrogen content of the resulting carbon aerogel. Pyrolysis is typically carried out in an inert atmosphere (i.e. nitrogen, helium, neon, argon or some combination).

In some embodiments, the three-dimensional carbon network comprises a polyimide-derived carbon aerogel. In some embodiments, the dried polyimide aerogel is subjected to a treatment temperature of 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the polyimide aerogel to obtain a polyimide-derived carbon aerogel.

The present disclosure involves the formation and use of three-dimensional carbon network, such as carbon aerogels, as electrode materials within an energy storage device, for example as the primary anodic material in a LIB. The pores of the porous network are designed, organized, and structured to accommodate particles of silicon or other metalloid or metal, and expansion of such particles upon lithiation in LIB, for example. Alternatively, the pores of the porous network may be filled with sulfide, hydride, any suitable polymer, or other additive where there is a benefit to contacting the additive with an electrically conductive material to provide for a more effective electrode.

To further expand on the exemplary application within LIBs, when carbon-based aerogel material is used as the primary electrode material e.g., anodic material as in examples of this present disclosure, the carbon aerogel porous core has a narrow pore size distribution, and provides for high electrical conductivity, high mechanical strength, and a morphology and sufficient pore volume (at a final density) to accommodate a high percentage by weight of silicon particles and expansion thereof.

In some examples, the surface of the three-dimensional carbon network may be modified via chemical, physical, or mechanical methods in order to enhance performance with electrochemically active species contained within the pores of the porous network.

Furthermore, it is contemplated herein that the three-dimensional carbon network, and specifically carbon aerogels, can take the form of monolithic structures. When monolithic in nature, the carbon aerogel eliminates the need for any binders; in other words, the anode can be binder-less. As used herein, the term “monolithic” refers to aerogel materials in which a majority (by weight) of the aerogel included in the aerogel material or composition is in the form of a unitary, continuous, interconnected aerogel nanostructure. Monolithic carbon aerogel materials include carbon aerogel materials which are initially formed to have a unitary interconnected gel or aerogel nanostructure, but which can be subsequently cracked, fractured or segmented into non-unitary aerogel nanostructures. Monolithic aerogels may take the form of a freestanding structure or a reinforced (fiber or foam) material. In comparison, using silicon lithiation as an example, silicon incorporated into a monolithic aerogel can be utilized more effectively relative to theoretical capacity, as compared to the same amount of silicon incorporated into a slurry using conventional processes.

Monolithic aerogel materials e.g., monolithic carbon aerogels are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (i.e., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically preparation of a paste or slurry from the powder, casting and drying onto a substrate, and may optionally include calendaring.

Particulate aerogel materials, e.g., carbon aerogel beads, provide certain advantages. For example, particulate materials can be used as a direct replacement for other materials such as graphite in LIB anodes and anode manufacturing processes. Particulate materials can also provide improved lithium-ion diffusion rates due to shorter diffusion paths within the particulate material. Particulate materials can also allow for electrodes with enhanced packing densities, e.g., by tuning the particle size and packing arrangement. Particulate materials can also provide improved access to silicon due to inter-particle and intra-particle porosity.

Carbon aerogels can be formed from inorganic materials, organic materials, or mixtures thereof. Carbon aerogels can be formed from inorganic aerogels, organic aerogels, or mixtures thereof. Inorganic aerogels, organic aerogels, or mixtures thereof may be carbonized to obtain the three-dimensional carbon network e.g., porous carbon aerogels of the present disclosure. Aerogels can be formed of inorganic materials, organic materials, or mixtures thereof. When formed of organic materials such as, for example, phenols, resorcinol-formaldehyde (RF), phloroglucinol-furfuraldehyde (PF), polyacrylonitrile (PAN), polyimide (PI), polyurethane (PU), polyurea (PUA), polyamine (PA), polybutadiene, polydicyclopentadiene, and precursors or polymeric derivatives thereof, the organic aerogel may be carbonized (e.g., by pyrolysis) to form a carbon aerogel, which can have properties (e.g., pore volume, pore size distribution, morphology, etc.) that differ or overlap from each other, depending on the precursor materials and methodologies used.

In some embodiments, the three-dimensional network comprises an organic material or is derived from an organic material, meaning the three-dimensional network may be a wet-gel or an aerogel comprising an organic material as described herein, or may be a carbon aerogel obtained or derived from an organic material as described herein (i.e., by pyrolysis of an organic material under conditions suitable to convert at least a portion of the organic material to carbon).

### Inorganic Aerogels

Inorganic aerogels are generally formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxysilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxysilane (TEOS), partially hydrolyzed TEOS, condensed polymers of TEOS, tetramethoxysilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain embodiments of the present disclosure, pre-hydrolyzed TEOS, such as Silbond® H-5 (SBH5, Evonik Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond® 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

### Organic Aerogels

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiene, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

In certain embodiments, aerogels of the present disclosure comprise a polyamic acid, a polyimide, or combination thereof, or are carbon aerogels obtained (i.e., derived) from a polyamic acid or polyimide by carbonization. In particular embodiments, the aerogel comprises a polyamic acid, a polyimide, or combination thereof, or is obtained by pyrolysis of a polyamic acid, a polyimide, or combination thereof. In some embodiments, the polyamic acid or polyimide is prepared in an aqueous solution (i.e., via an aqueous sol-gel process). Reference herein to an aqueous solution or aqueous sol-gel process means that the solution or aqueous sol-gel process is substantially free of any organic solvent. The term “substantially free” as used herein in the context of organic solvents means that no organic solvent has been intentionally added, and no organic solvent is present beyond trace amounts. For example, in certain embodiments, an aqueous solution can be characterized as having less than 1% by volume of organic solvent, or less than 0.1%, or less than 0.01%, or even 0% by volume of organic solvent.

Utilization of an aqueous sol-gel process is advantageous in providing rapid gelation, making the process amenable to configuration in a continuous process, for example, for preparing polyimide beads. Aqueous sol-gel processes for preparing polyamic acid and polyimide gel materials are economically preferable to conventional methods of such materials (e.g., expensive organic solvents are avoided, and disposal costs are minimized) and “green” (i.e., beneficial from an environmental standpoint, as potentially toxic organic solvents are avoided and production of toxic byproducts is minimized or eliminated), and are advantageous in potentially reducing the overall number of operations which must be performed to provide carbon or polyamic acid/polyimide gel materials. As disclosed in International Patent Application Publication No. WO2022/125835, and International Patent Application PCT/US2023/016821, each of which is incorporated by reference herein in their entirety, polyamic acid and polyimide gels can be prepared in water, in monolithic or bead form, the gels may be converted to aerogels, which possess nanostructures with similar properties to aerogels prepared by a conventional organic solvent-based process, and the aerogels optionally pyrolyzed to form a corresponding carbon aerogel.

In some embodiments, the aerogel of the present disclosure is a polyamic acid aerogel, in monolithic or bead form, wherein the polyamic acid is prepared by acidification of an aqueous solution of a polyamic acid. In some embodiments, the polyamic acid is dissolved in water in the presence of a base (e.g., an alkali metal hydroxide or non-nucleophilic amine base). In other embodiments, the polyamic acid is prepared in situ under aqueous conditions, directly forming the polyamic acid salt solution. In some embodiments, the polyamic acid is any commercially available polyamic acid. In other embodiments, the polyamic acid has been previously formed (“pre-formed”) and isolated, e.g., prepared by reaction of a diamine and a tetracarboxylic dianhydride in an organic solvent according to conventional synthetic methods. In some embodiments, the aqueous solution of a polyamic acid salt is prepared in situ by e.g., reaction of a diamine and a tetracarboxylic acid dianhydride in the presence of a non-nucleophilic amine, providing an aqueous solution of the polyamic acid ammonium salt. Suitable methods for preparing polyamic acid aerogels under such aqueous conditions are disclosed in WO2022/125835 and PCT/US2023/016821, previously incorporated by reference.

In some embodiments, the aerogel of the present disclosure is a polyimide aerogel, in monolithic or bead form, wherein the polyimide is prepared by thermal or chemical imidization of a polyamic acid in aqueous solution. Suitable methods of forming monoliths and beads (e.g., utilizing droplet or emulsion-based processes) under such aqueous conditions are disclosed in WO2022/125835 and PCT/US2023/016821, previously incorporated by reference.

### Organic/Inorganic Hybrid Aerogels

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R-Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

In certain embodiments, aerogels of the present disclosure are inorganic silica aerogels formed primarily from prepolymerized silica precursors preferably as oligomers, or hydrolyzed silicate esters formed from silicon alkoxides in an alcohol solvent. In certain embodiments, such prepolymerized silica precursors or hydrolyzed silicate esters may be formed in situ from other precursors or silicate esters such as alkoxy silanes or water glass. However, the disclosure as a whole may be practiced with any other aerogel compositions known to those in the art and is not limited to any one precursor material or amalgam mixture of precursor materials.

### Silicon Particles

The silicon is generally present in the composite material as silicon particles. Silicon may also be present in the form of a thin film e.g., a thin film including silicon formed after vapor deposition of silicon (e.g., chemical vapor deposition) into the composite material.

Within the context of the present disclosure, the term “silicon particles” refers to silicon or silicon-based materials with a range of particle sizes. The particle size of the silicon in the composite material may vary. Silicon particles of the present disclosure can be nanoparticles, e.g., particles with two or three dimensions in the range of about 1 nm to about 150 nm. Silicon particles of the present disclosure can be fine particles, e.g., micron-sized particles with a maximum dimension, e.g., a diameter for a substantially spherical particle, in the range of about 150 nm to about 10 micrometers or larger. For example, silicon particles of the present disclosure can have a maximum dimension, e.g., a diameter for a substantially spherical particle, of about 10 nm, 50 nm, 60 nm, 80 nm, 100 nm, 120 nm, 130 nm, 140 nm, 150 nm, 180 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values.

In some embodiments, the silicon particles can be monodispersed or substantially monodispersed. In other embodiments, the silicon particles can have a particle size distribution. Within the context of the present disclosure, the dimensions of silicon particles are provided based upon the median of the particle size distribution, i.e., the D50. In some embodiments, the silicon in the composite material has an average particle size of about 1 μm or less.

Silicon particles of the present disclosure can be silicon wires, crystalline silicon, amorphous silicon, silicon alloys, silicon oxides (SiOx), and any combinations thereof. The particles, e.g., particles of electroactive materials such as silicon particles, can have various shapes to embodiments disclosed herein. In some embodiments, silicon particles disclosed herein can be substantially spherical. In other embodiments, particles of electroactive materials can be substantially planar, cubic, obolid, elliptical, disk-shaped, or toroidal.

In an example, prior to formation of a sacrificial layer, the silicon particle (e.g., silicon nanoparticle) surface can be modified with functional groups that can aid in dispersing the silicon particles in a porous network. In another example, formation of the sacrificial layer may can further aid in dispersing the silicon particles in a porous network. In an example, the porous network can be a sol-gel, aerogel, xerogel, foam structure, among others. In some embodiments, the porous network is carbonized to obtain three-dimensional carbon network of the present disclosure according to multiple embodiments disclosed herein.

For example, functional groups can be grafted onto the surface of the silicon particles by covalent bonds. Before functionalization, the surface of the silicon particles includes silane groups, such as silicon hydride, and/or silicon oxide groups. In some embodiments, at least a portion of those silane and silicon oxide groups can be present in combination with the bonded functional groups after functionalization of the surface of the silicon particle, e.g., the silicon particle surface can include silane groups and the covalently attached functional groups, silicon oxide groups and the covalently attached functional groups, or both silane and silicon oxide groups and the covalently attached functional groups. The presence of the functional groups on the surface of the silicon particles can be detected by various techniques, for example, by infrared spectroscopy.

The surface of the silicon particles can be functionalized with hydrophilic groups to aid in improved dispersion within the porous network. Without being bound by theory, the functionalization with hydroxide groups creates increased covalent bonding between the surface groups on the silicon particles and the porous network. As a result, the functionalized silicon particles can be uniformly dispersed within the porous network. For example, hydrophilic hydroxide groups can be grafted to the surface of the particles by unsaturated glycol to increase the hydrophilicity of silicon particle surfaces. Increasing the hydrophilicity of the silicon particles allows for the particles to be and remain more uniformly dispersed in the network and remain uniformly dispersed in the network in any additional processing (e.g., pyrolysis). In an example, functionalization via glycol can improve the dispersion of silicon particles within a polyimide sol-gel and/or aerogel or carbon aerogel. Any suitable glycol can be used including, but not limited to, ethylene glycol methyl ether methacrylate and polyethylene glycol methyl ether methacrylate, among others.

In some embodiments, the individual silicon particles are dispersed heterogeneously throughout the three-dimensional carbon network. In some embodiments, the individual silicon particles are dispersed homogenously throughout the three-dimensional carbon network. The expression “homogenously dispersed” refers to a distribution of the Si particles throughout the three-dimensional carbon network without large variations in the local concentration across the accessible network surface.

In some embodiments, about 30 wt % to 70 wt %, about 20 wt % to about 50 wt % of the dispersed individual silicon particles within the plurality of silicon particles are in an agglomerated state. In some embodiments, less than about 30 wt %, less than about 20 wt %, less than about 10 wt % of the dispersed individual silicon particles within the plurality of silicon particles are in an agglomerated state. In some embodiments, homogenously distributed Si particles may refer to a distribution of the plurality of Si particles throughout the porous polymer network having less than about 30 wt %, less than about 20 wt %, less than about 10 wt % of the dispersed individual silicon particles within the plurality of silicon particles in an agglomerated state.

### Sacrificial Particles

In exemplary embodiments, the composite material includes sacrificial particles. In some embodiments, sacrificial particles of the present disclosure are made from sacrificial materials. In some embodiments, sacrificial particles of the present disclosure include sacrificial materials.

Within the context of the present disclosure, the term “sacrificial material” refers to a material that is intended to be sacrificed or at least partially removed in response to mechanical, thermal, chemical and/or electromagnetic conditions experienced by the material. For example, the sacrificial material can decompose when exposed the high temperatures or high and/or continuous stress.

The sacrificial material can be selected from the group consisting of siloxanes, polyolefins, polyurethanes, phenolics, melamine, cellulose acetate, and polystyrene. In some cases, material layer is in the form of foam. In some embodiments, the sacrificial material can be worn away due to exposure to mechanical (such as cyclical) loads. In some embodiments, sacrificial layer decomposes after exposure to a singular mechanical, chemical and/or thermal event.

In some embodiments, the onset temperature of chemical decomposition of the sacrificial material is in the range of about 100° C. to about 700° C., about 100° C. to about 500° C., about 200° C. to about 400° C. The sacrificial particles can be made of polymers, metals, natural and synthetic organics, salts, ceramic compounds or combination thereof.

Polymers for use in the sacrificial material can be selected from a wide variety of thermoplastic resins, blends of thermoplastic resins, or thermosetting resins. Examples of thermoplastic resins that can be used include polyacetals, polyacrylics, styrene acrylonitrile, polyolefins, acrylonitrile-butadiene-styrene, polycarbonates, polystyrenes, polyethylene terephthalates, polybutylene terephthalates, polyamides such as, but not limited to Nylon 6, Nylon 6,6, Nylon 6,10, Nylon 6,12, Nylon 11 or Nylon 12, polyamideimides, polyarylates, polyurethanes, ethylene propylene rubbers (EPR), polyarylsulfones, polyethersulfones, polyphenylene sulfides, polyvinyl chlorides, polysulfones, polyetherimides, polytetrafluoroethylenes, fluorinated ethylene propylenes, polychlorotrifluoroethylenes, polyvinylidene fluorides, polyvinyl fluorides, polyetherketones, polyether etherketones, polyether ketone ketones, and the like, or a combination comprising at least one of the foregoing thermoplastic resins.

Examples of blends of thermoplastic resins that can be used in the sacrificial material include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether ether ketone/polyethersulfone, styrene-butadiene rubber, polyethylene/nylon, polyethylene/polyacetal, ethylene propylene rubber (EPR), and the like, or a combination comprising at least one of the foregoing blends.

Examples of polymeric thermosetting resins that can be used in the sacrificial material include polyurethanes, epoxies, phenolics, polyesters, polyamides, silicones, and the like, or a combination comprising at least one of the foregoing thermosetting resins. Blends of thermosetting resins as well as blends of thermoplastic resins with thermosetting resins can be used.

In some embodiments, the sacrificial particles comprise a polymer having a pyrolysis yield of less than 30 wt %, less than 20 wt %, less than 18 wt %, less than 15 wt %, less than 10 wt %, less than 8.0 wt %, or less than 5.0 wt %.

In some embodiments, the sacrificial particles are formed from a material selected from polymethylmethacrylate (PMMA), polyvinylpyrrolidone (PVP), polyvinyl acetate (PVAc), polyvinyl alcohol (PVA), polyacrylonitrile (PAN), polypropylene oxide (PEO), polypropylene oxide (PPO), polyethyleneimine (PEI), polyurethane, poly(3,4-ethylenedioxythiophene) (PEDOT), polyvinylbutyral, polyethylene oxide copolymer, polypropylene oxide copolymer, polycarbonate (PC), polyvinylchloride (PVC), polycaprolactone, polyvinylidene fluoride, polystyrene or combination thereof.

In some embodiments, the sacrificial particles comprise polystyrene, polyester, polymethacrylate, polyacrylate, polyethylene glycol, polyacid amides, polynorbornene, or combination thereof. In one embodiment, the sacrificial particles comprise poly(methyl methacrylate).

The sacrificial particles are typically provided from the same source and have a known, desired particle size, shape, porosity and other material attributes that are substantially similar. In some examples, the sacrificial particles have a diameter of less than 1000 nm, less than 800 nm, less than 500 nm, less than 300 nm, less than 250 nm, less than 200 nm, less than 150 nm or less than 100 nm.

### Lithium-Ion Batteries

A basic embodiment of a lithium-ion battery includes: a cathode; an anode in electrical communication with the cathode; an electrolyte disposed between the anode and the cathode; and a separator also disposed between the anode and the cathode.

The electrolytes are ionically conductive materials and may include solvents, ionic liquids, metal salts, ions such as metal ions or inorganic ions, polymers, ceramics, and other components. An electrolyte may be an organic or inorganic solid or a liquid, such as a solvent (e.g., a non-aqueous solvent) containing dissolved salts. Non-aqueous electrolytes can include organic solvents, such as, cyclic carbonates, linear carbonates, fluorinated carbonates, benzonitrile, acetonitrile, tetrahydrofuran, 2-methyltetrahydrofuran, γ-butyrolactone, dioxolane, 4 methyldioxolane, N,N-dimethylformamide, N,N-dimethylacetamide, dimethyl sulfoxide, dioxane, 1,2-dimethoxyethane, sulfolane, dichloroethane, chlorobenzene, nitrobenzene, diethylene glycol, dimethyl ether, and mixtures thereof. Example salts that may be included in electrolytes include lithium salts, such as LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ+1SO₂)(C_{y}F_{2y}−1SO₂), (where x and y are natural numbers), LiCl, LiI, and mixtures thereof. In some embodiments, the liquid molecules comprise an electrolyte solvent (an electrolyte). The electrolyte solvent of the present disclosure can be selected from any of the suitable electrolyte described above. Particularly, the electrolyte is selected from ethylene carbonate (EC), diethyl carbonate (DEC), dimethyl carbonate (DMC), fluoroethylene carbonate (FEC), fluorinated ether (F-EPE), 1,3-dioxolane (DOL), dimethoxy ethane (DME), or combination thereof.

The separators are typically thin, porous or semi-permeable, insulating films with high ion permeabilities. The separators can be composed of polymers, such as olefin-based polymers (e.g., polyethylene, polypropylene, and/or polyvinylidene fluoride). If a solid polymer electrolyte is used as the electrolyte, the solid polymer electrolyte may also act as the separator.

The anodes are composed of an active anode material that takes part in an electrochemical reaction during the operation of the battery. Example anode active materials include elemental materials, such as lithium; alloys including alloys of Si and Sn, or other lithium compounds; and intercalation host materials, such as graphite. By way of illustration only, the anode active material may include a metal and/or a metalloid alloyable with lithium, an alloy thereof, or an oxide thereof. Metals and metalloids that can be alloyed with lithium include Si, Sn, Al, Ge, Pb, Bi, and Sb. For example, an oxide of the metal/metalloid alloyable with lithium may be lithium titanate, vanadium oxide, lithium vanadium oxide, SnO₂, or SiOₓ (0<x<2).

The cathodes are composed of an active cathode material that takes part in an electrochemical reaction during the operation of the battery. The active cathode materials may be lithium composite oxides and include layered-type materials, such as LiCoO₂; olivine-type materials, such as LiFePO₄; spinel-type materials, such as LiMn₂O₄; and similar materials. The spinel-type materials include those with a structure similar to natural spinal LiMn₂O₄, that include a small amount nickel cation in addition to the lithium cation and that, optionally, also include an anion other than manganate. By way of illustration, such materials include those having the formula LiNi_{(0.5-x)}Mn_{1.5}MₓO₄, where 0≤x≤0.2 and M is Mg, Zn, Co, Cu, Fe, Ti, Zr, Ru, or Cr.

Within the context of the present disclosure, the term “cycle life” refers to the number of complete charge/discharge cycles that an anode or a battery (e.g., LIB) is able to support before its capacity falls under about 80% of its original rated capacity. Cycle life may be affected by a variety of factors, for example mechanical strength of the underlying substrate (e.g., carbon aerogel) and maintenance of interconnectivity of the aerogel. It is noted that these factors actually remaining relatively unchanged over time is a surprising aspect of certain examples of the present disclosure. Cycle life may be determined by methods known in the art, for example including, but not limited to, cycle testing, where battery cells are subject to repeated charge/discharge cycles at predetermined current rates and operating voltage. Within the context of the present disclosure, measurements of cycle life are acquired according to this method, unless otherwise stated. Energy storage devices, such as batteries, or electrode thereof, can have a cycle life of about 25 cycles or more, 50 cycles or more, 75 cycles or more, 100 cycles or more, 200 cycles or more, 300 cycles or more, 500 cycles or more, 1000 cycles or more, or in a range between any two of these values.

The present disclosure includes an electrical energy storage device with at least one anode comprising the composite material of present technology as described herein, at least one cathode, and an electrolyte with lithium ions. The electrical energy storage device can have a first cycle efficiency (i.e., a cell's coulombic efficiency from the first charge and discharge) of at least 10%, 20%, 30%, 40%, 50%, 60%, 70%, any intervening value (e.g., 65%) or in a range between any two of these values (e.g., ranges from about 30% to about 50%). As previously described herein, reversible capacity can be at least 150 mAh/g. The at least one cathode can be selected from the group consisting of conversion cathodes such as lithium sulfide and lithium air, and intercalation cathodes such as phosphates and transition metal oxides.

According to different embodiments, the composite materials of the present disclosure may be applied to both the positive electrode and the negative electrode of electrochemical energy storage devices, or to the electrodes individually (either the positive electrode or the negative electrode). In various embodiments, a cathode, anode, or solid-state electrolyte material is coated with the composite materials of the present technology.

### Examples

The following examples are included to demonstrate preferred embodiments of the technology. However, those of skill in the art should, in light of the present disclosure, appreciate that many changes can be made in the specific embodiments which are disclosed and still obtain a like or similar result without departing from the spirit and scope of the technology.

### 1.1 Oxidation of Silicon Particles

Commercially available silicon particles may or may not include oxidized (partially or completely) silicon particles. Therefore, depending on the surface functionalities of silicon particles provided by commercial providers, the oxidation step provided herein is optional.

Silicon particles (10-100 g of 100-3000 nm; available from Evonik) were either heated in the temperature range of 400-850° C. under moisture for 1-5 hours or dispersed in 10-1000 mL of 0.1-5M sulphochromic acid or 10-1000 mL of 1-10M H₂O₂ (hydrogen peroxide). For the Si dispersion, it was heated to 50-120° C. for 1-10 hours under constant stirring in order to obtain hydroxyl functional groups (or silanol groups) on the surface of silicon particles. In principle, other oxidizing agents can also be used for this purpose. After 1-10 hour of stirring the solution, the solution was cooled to room temperature and centrifuged to obtain oxidized silicon particles. The obtained silicon particles were washed with 100-3000 mL of water 3-5 times to remove any residual acid and dried under ambient conditions for 3-10 hours. The surface oxidation was confirmed by IR spectrum as evidenced by the reduced intensity of band at 2105 and 1993 cm⁻¹ and the increase of band intensity at 1052 cm⁻¹. The oxidation by heating dry powder can also be confirmed by the mass increase after the treatment.

### 1.2 Synthesis of Sacrificial Particles (PMMA Nanospheres) without Crosslinking

80 gram of water and 20 grams of monomeric methyl methacrylate were added to beaker which was stirred on a hot plate at 500 RPM with solution temperature controlled at 80° C. for 15 minutes. 1.8 gram of ammonium persulfate was added to the solution as an initiator. The stirring speed was then lowered to 300 RPM after 60 minutes. When the color of the solution changed from transparent to milky, the stirring speed was raised to 500 RPM again. The solution was stirred for another r 180 minutes before 2.1 gram of polymer modifier (Hydroxyethyl) methacrylate was added. The solution temperature was changed to 60° C. and the solution was stirred overnight. The synthesis of PMMA nanospheres in emulsion was done by the next morning.

### 1.3 Synthesis of Sacrificial Particles (PMMA Nanospheres) with Crosslinking

80 gram of water and 20 gram of monomeric methyl methacrylate were added to beaker which was stirred on a hot plate at 500 RPM with solution temperature controlled at 80° C. for 15 minutes. 1.8 gram of ammonium persulfate was added to the solution as an initiator. The stirring speed was then lowered to 300 RPM after 60 minutes. When the color of the solution changes from transparent to milky, the stirring speed was raised to 500 RPM again. 1.8 gram of 1,3-butanediol dimethacrylate was added to the solution as a crosslinking reagent immediately. The solution was stirred for another 180 minutes before 2.1 gram of polymer modifier (hydroxyethyl) methacrylate was added. Changed the solution temperature to 60° C. and was stirred overnight. The synthesis of PMMA nanospheres in emulsion was done by the next morning.

### 1.4 Synthesis of Composite Si/C Materials Containing Mega Pores

In a typical synthesis, 12.7 g of p-phenylenediamine (PDA) was added to 313 g water in a beaker and stirred for 30 min until all the PDA is dissolved. Then 28.5 g of triethylamine was added to the solution and stirred for 10 min. After that 25.5 g of benzene-1,2,4,5-tetracarboxylic anhydride was added to the above solution and stirred for 4 h. Then, 1.5-25 g PMMA nanospheres and optionally 14.4 g oxidized Si particles were then added to the above solution and stirred for 10 min. 51.4 g acetic anhydride was then poured into the above suspension and stirred for 50 s before pouring it all into 1200 mL mineral spirits with surfactant under mixing at 3600 rpm. The obtained emulsion was then aged overnight before filtration. After finishing filtration, the obtained material was rinsed with ethanol for several times and dried in the oven at 70° C. The final product was obtained by carbonizing the above dried material at 800-1200° C. under inert gas atmosphere (N₂ or Ar) for 2-10 h.

While this disclosure has been particularly shown and described with reference to example embodiments thereof, it will be understood by those skilled in the art that various changes in form and details may be made therein without departing from the scope of the technology encompassed by the appended claims.

What is claimed is:

1. A mixture for forming a suspension, the mixture comprising:
a. a sol-gel composition, wherein the sol-gel composition is an aerogel precursor, a xerogel precursor, an ambigel precursor, an aerogel-xerogel hybrid material precursor, an aerogel-ambigel hybrid material precursor, an aerogel-ambigel-xerogel hybrid material precursor, or combinations thereof; and
b. sacrificial particles having a surface, wherein the sacrificial particles are dispersed throughout the sol-gel composition, and wherein the sacrificial particles comprise a polymer.

2. A composite material comprising:
a. a three-dimensional network; and
b. sacrificial particles dispersed throughout the three-dimensional network, the sacrificial particles comprising a polymer.

3. The composite material of claim 2, further comprising silicon particles, dispersed throughout the three-dimensional network.

4. The composite material of claim 2, wherein the three-dimensional network comprises an aerogel, a xerogel, an ambigel, an aerogel-xerogel hybrid material, an aerogel-ambigel hybrid material, an aerogel-ambigel-xerogel hybrid material, or combinations thereof.

5. The composite material of claim 2, wherein the three-dimensional network comprises a polyimide or is derived from a polyimide.

6. The composite material of claim 3, wherein a total volume of the sacrificial particles is less than three times a total volume of the silicon particles.

7. The composite material of claim 3, wherein a diameter of the sacrificial particles is at least 1.6 times greater than a diameter of silicon particles.

8. The composite material of claim 2, wherein the three-dimensional network comprises from about 40% to about 80% by weight of the sacrificial particles, based on the total weight of the three-dimensional network.

9. The composite material of claim 2, wherein the three-dimensional network has a porosity between about 10% and about 70%.

10. The composite material of claim 2, wherein the three-dimensional network has a pore volume of more than about 0.3 cc/g and less than about 2.5 cc/g.

11. A composite material comprising mega pores and further comprising:
a. a three-dimensional carbon network; and
b. optional silicon particles, wherein the silicon particles are dispersed throughout the three-dimensional carbon network, wherein the mega pores have an internal diameter in a range from about 50 nm to about 1000 nm.

12. The composite material of claim 11, wherein the composite material has a porosity between about 50% and about 90%.

13. The composite material of claim 11, wherein the three-dimensional carbon network comprises a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof.

14. The composite material of claim 11, wherein at least some of the mega pores are formed by carbonizing a plurality of sacrificial particles dispersed throughout a three-dimensional network.

15. The composite material of claim 11, wherein the three-dimensional network comprises an aerogel, a xerogel, an ambigel, an aerogel-xerogel hybrid material, an aerogel-ambigel hybrid material, an aerogel-ambigel-xerogel hybrid material, or combinations thereof.

16. The composite material of claim 11, wherein the sacrificial particles comprise poly(styrene), poly(ester), poly(methacrylate), poly(acrylate), poly(ethylene glycol), poly(acid amides), poly(norbornene), or combination thereof.

17. An energy storage system comprising the composite material of claim 11.

18. A method of preparing a composite material comprising mega pores having an internal diameter in a range from about 50 nm to about 1000 nm, the method comprising:
a. providing silicon particles and sacrificial particles, each of the silicon particles and sacrificial particles comprising a surface, and wherein the sacrificial particles comprise a polymer;
b. optionally functionalizing the surface of the silicon particles;
c. optionally crosslinking the sacrificial particles and optionally functionalizing the surface of the sacrificial particles to increase hydrophilicity;
d. providing a sol-gel solution, the sol-gel solution comprising a polar solvent and a precursor of a three-dimensional network;
e. processing the silicon particles and the sacrificial particles in the presence of the sol-gel solution to yield the three-dimensional network comprising the silicon particles and the sacrificial particles dispersed throughout the three-dimensional network; and
f. pyrolyzing the three-dimensional network comprising the silicon particles and the sacrificial particles dispersed throughout the three-dimensional network to obtain the composite material comprising mega pores.
